(19) United States
(12) Patent Application Publication
(10) Pub. No.: US 2019/0376003 A1
(43) Pub. Date: Dec. 12, 2019

(54) COMPOSITION COMPRISING MIXTURES OF GLUCAMIDES, PROCESS FOR THEIR PREPARATION AND THEIR USE

(71) Applicant: Clariant International Ltd., Muttenz (CH)

(72) Inventor: Aleksandra SIENKIEWICZ, Frankfurt am Main (DE)

(73) Assignee: Clariant International Ltd., Muttenz (CH)

(21) Appl. No.: 16/463,335

(22) PCT Filed: Nov. 21, 2017
(86) PCT No.: PCT/EP2017/079959

§ 371 Date: May 22, 2019

(30) Foreign Application Priority Data
Dec. 2, 2016 (EP) 16202029.1

(51) Int. Cl. C11D 1/645; C11D 17/04; C11D 11/00; C11D 1/52

(52) U.S. Cl. CPC C11D 1/645; C11D 1/525; C11D 11/0094; C11D 17/043

(57) ABSTRACT

Composition comprising mixtures of glucam ides, process for their preparation and their use

Disclosed are compositions comprising
a) 20 to 84% by weight of specific N-hydrocarbon-N-acylglucamide blend,
b) 15 to 50% by weight of water, and
c) 1 to 30% by weight of one or more other additives.

The compositions may be present, at a temperature of 20 ° C., in the form of a gel or in the form of a paste, and furthermore e.g. in the form of a monodose product.

The compositions are suitable for cleaning, scenting, conditioning or disinfection purposes, preferably in home or personal care applications.

### DESCRIPTION

This invention relates to compositions comprising a specific blend of N-hydrocarbon-N-acylglucamides and water, to the use of these compositions for cleaning, scenting, conditioning or disinfection purposes, especially in sanitary facilities, and to a process for the preparation of these compositions.

Detergents and cleaning agents are commonly present as spray-dried or granulated products or as liquids, but following the new tendencies of the growing premium segment and the desire of the consumer for other possibilities of a comfortable dosage, the search for new formats for detergent and cleaning agents has significantly increased.

Nowadays, monodose products are quite popular in home care applications, such as in sanitary applications, e.g. for in-bowl toilet cleaners, in automatic dishwashing or laundry applications. The monodose products frequently are present as tablets or pouches comprising powders, liquids or gels. However, the chemical composition of these monodose products, in particular of the gels, is often very complex and is in need of substances such as thickeners. This in turn enhances the complexity of their production and also the costs associated therewith.

In WO 2013/178668 A2 a water based surfactant solution is described, which is suitable for cosmetic application and is containing: (a) 28 to 65 wt.-% of a mixture of (a1) 5 to 20 wt.-% of N-methyl-N-oleylglucamide, (a2) 50 to 93 wt.-% of N-methyl-N-C₁₂-C₁₄-acylglucamides, (a3) 0 to 30 wt.-% of other N-methyl-N-acylglucamides, components (a1), (a2) and (a3) adding up to 100 wt.-%, (b) 0 to 20 wt.-% of one or more alcohols, (c) 20 to 72 wt.-% of water, and (d) 0 to 5 wt.-% of additives, components (a), (b), (c) and (d) adding up to 100 wt.-%. The disclosed surfactant solution does not form a gel upon dilution with water. The melting points of the disclosed surfactant mixtures are 38° C. or lower.

U.S. Pat. No. 5,510,049 A corresponding to WO 95/07340 A1 describes laundry or toilet bars comprising one or more surface active agents, such as anionic surfactants, soaps, and synthetic detergents prepared using an alkoxy or aryloxy polyhydroxy fatty acid amide, to improve bar smear, cracking or wearing qualities. Palm oil chain-length fatty acid amides of N-(3-methoxypropyl) glucamine and N-(2-methoxyethyl) glucamine are examples of the glucamide surfactant used in such bars.

WO 2012/113671 A1 discloses an adhesive composition in gel or paste form for cleaning and/or fragrancing of a WC, which is applied to the inside of the WC ceramic and is rinsed off only after several flush operations, comprises at least one surfactant from the group consisting of alkyl polyglycosides, amphoacetates, amphodiacetates, betaines, fatty alcohol ether carboxylic acids, fatty acid sarcosinates, cocamidopropylamine oxide, aminopropionates, and biosurfactants, perfume and water, and also an ester of polyisobutene succinic acid as an adhesion promoter, and is free of further adhesion promoters and surfactants.

WO 02/26925 A1 describes a sanitary product for cleaning and/or disinfecting and/or releasing fragrances. Said product can be applied directly to the sanitary object, adhering thereto, and can only be removed after many flushing processes. The product contains water; anionic and/or non-ionic and/or amphoteric surfactants; an adhesive agent from the group consisting of polyalkoxyalkanes, alginates, diurethanes, gelatines, pectins, oleyamines, alkyldimethylaminoxides, stearates, sulfonates, sulfates and carbonates; at least one aliphatic di-, oligo-, or polyhydroxy compound or the ether of the same; and optionally other standard constituents such as thickeners, dyes, preservatives and fragrances. The viscosity of the product is measured as at least 15,000 mPa·s, by means of a Haake viscometer (cone/plate system, sensor PK 5 1°), at a shear gradient of 25 s⁻¹ and at room temperature.

WO 99/66017 discloses a sanitary agent for cleaning and/or disinfecting and/or releasing an odorant, said agent comprising an adhesion promoter, water, anionic and/or non-ionic and/or amphoteric surface active agents and, optionally, further common constituents such as odorants, thickeners, colorants and preservatives. The adhesion promoter is selected from the group of very long or long-chained organic molecules which are hydrophilic at least in part. The hydrophilic part of the adhesion promoter interacts at least in part with the water molecules in the presence of water and becomes “sticky” so that the agent can be applied directly on the sanitary object in the presence of small amounts of water and can adhere thereto. The viscosity of the agent is at least 15,000 mPa·s and the product can only be washed away completely after numerous rinsings. This document also discloses a method for applying a sanitary agent, wherein the agent is directly applied on the surface of the sanitary object to be cleaned and adheres to said surface.

WO 99/24549 describes a detergent tablet comprising: A) a compressed solid body portion having at least one mold in the compressed body portion; and B) a non-compressed, gelatinous portion integrally mounted in the mold of the compressed body portion, wherein the gelatinous portion comprising a thickening system and at least one detergent active. The thickening system preferably includes a non-aqueous diluent and a gelling agent and the detergent active is preferably selected from the group consisting of enzymes, surfactants, effervescing agents, bleaching agents, silver care agents, builders, and mixtures thereof.

It is an object of the present invention to provide new compositions which may be present, at a temperature of 20° C., in the form of a gel or a paste, and furthermore e.g. in a monodose format, and are suitable for cleaning, scenting, disinfection or conditioning purposes, preferably in home or personal care applications.

It is another object of the present invention to provide new compositions which are self-adhesive on the surfaces of different objects, preferably of sanitary objects.

These compositions do not need tackifiers or adhesion promoters for safe adherence at the surface of a device.

Surprisingly it has now be found that these objects can be solved with the compositions described below.

Therefore, the present invention relates to compositions melting at a temperature of at least 45° C. comprising:
a) 20 to 84 wt.-% of a blend of N-hydrocarbon substituted-N-acylglucam ides of the formula (I)

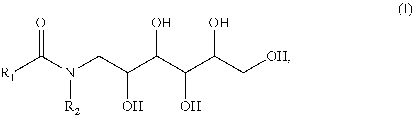

wherein
R₁ is a linear or branched, preferably a linear, alkyl group comprising 7 to 21 and preferably 7 to 17 carbon atoms or a linear or branched, preferably a linear, mono- or polyunsaturated alkenyl group comprising 7 to 21, preferably 7 to 17 carbon atoms,
R2 is a linear or branched alkyl group or an aryl group, preferably a linear alkyl group comprising 1 to 6 carbon atoms or a phenyl group, more preferred a methyl, ethyl, propyl or butyl group and most preferred a methyl group,
wherein the blend of N-hydrocarbon substitued-N-acylglucam ides comprises:
(a1) 3 to 35 wt.-% of one or more N-hydrocarbon-N-acylglucamide(s) of formula (I), wherein R₁ is a linear or branched, preferably a linear, alkyl group comprising 7 to 9 carbon atoms or a linear or branched, preferably a linear, mono- or polyunsaturated alkenyl group comprising 7 to 9 carbon atoms,
(a2) 15 to 75 wt.-% and preferably 17 to 47 wt.-% of one or more N-hydrocarbon-N-acylglucamide(s) of formula (I), wherein Ri is a linear or branched, preferably a linear, alkyl group comprising 11 to 13 carbon atoms or a linear or branched, preferably a linear, mono- or polyunsaturated alkenyl group comprising 11 to 13 carbon atoms,
(a3) 2 to 55 wt.-% of one or more N-hydrocarbon-N-acylglucamide(s) of formula (I), wherein R₁ is a linear or branched, preferably a linear, mono- or polyunsaturated alkenyl group comprising 11 to 17 carbon atoms, which are different from the N-hydrocarbon-N-acylglucamide(s) of components (a2) and (a4), most preferred an oleyl group, and
(a4) 2 to 12 wt.-% of one or more additional N-hydrocarbon-N-acylglucamides of formula (I) which are different from the N-hydrocarbon-N-acylglucam ides of components (a1), (a2), and (a3),
b) 15 to 50 wt.-% of water, and
c) 1 to 30 wt.-% of one or more additives, wherein the total amount of components a) and c) is at least 50 wt.-%, and wherein the percentages refer to the total weight of the composition.

The N-hydrocarbon-N-acylglucam ides of the formula (I) may be prepared by methods well-known to the person skilled in the art and/or are commercially available.

The present invention in particular concerns a gel or paste material obtained by the association of a blend of various N-hydrocarbon-N-acylglucam ides of the formula (I) with a carbon chain length between 7 and 21 and water in determined amounts and without the necessity of any thickener or hardener system addition.

The gels of the present invention are semirigid jelly-like products in which water and optionally other liquids, such as alcohols, are dispersed in a solid. These gels are a dispersion of molecules of one or more liquids within a solid in which the solid is the continuous phase and the liquid is the discontinuous phase. The gels of the present invention can have properties ranging from soft and weak to hard and tough. They preferably show viscoelastic properties and exhibit no flow when under low shear stress conditions, e.g. below 200 Pa.

The pastes of the present invention behave as a solid until a sufficiently large load or stress is applied, at which point these pastes flow like a fluid. These pastes typically comprise a suspension of granular material in a background fluid. The individual grains are jammed together forming a disordered, glassy or amorphous structure, and giving the pastes their solid-like character.

In the inventive compositions the combination of various selected N-hydrocarbon-N-acylglucamides of the formula (I) with a carbon chain length between 7 and 21 in combination with selected amounts of water and optionally with low amounts of organic co-solvents preferably results in homogenous gels with surprisingly high viscosity.

Preferred components (a1) are N-methyl-N-acylglucamide(s) of formula (I), wherein R₁ is a linear or branched, preferably a linear, alkyl group comprising 7 to 9 carbon atoms.

Preferred components (a2) are N-methyl-N-acylglucamide(s) of formula (I), wherein Ri is a linear or branched, preferably a linear, alkyl group comprising 11 to 13 carbon atoms.

Preferred components (a3) are N-methyl-N-acylglucamide(s) of formula (I), wherein R₁ is a linear or branched, preferably a linear, mono-unsaturated alkenyl group comprising 11 to 17 carbon atoms, most preferred N-methyl-N-oleylglucamine of formula (I).

Preferred components (a4) are N-hydrocarbon-N-acylglucamides of formula (I) which are different from the N-hydrocarbyl-N-acylglucam ides of components (a1), (a2), and (a3), wherein R₁ is a linear or branched, preferably a linear, alkyl group comprising 7 to 21 carbon atoms.

The gel aspect is generated by the association of N-hydrocarbon N-acylglucamide of the formula (I) with various carbon chain length and water in determined amounts and can find possible applications in cleaners, disinfectant vehicles, laundry detergent, softener and air freshener products. This property dispenses highly precise and costly processes for detergent manufacturers for the production of e.g. detergent tablets, toilet blocks and gel detergents. Also, this property dispenses the usage of a thickener or hardener system, typically a polymeric gelling additive, e.g. polysaccharides, polyethylene glycols, or polyacrylic acid polymers. Moreover, aesthetically, this material aspect allows the detergent producer to develop innovative designs which are attractive to the end consumer and offers different format alternatives.

The inventive compositions are notable for very good storage stability at ambient conditions, i.e. at 40 to 60% r.h. (relative humidity) and a temperature of 24° C. The inventive compositions in a gel form are soft and easily deformable.

The inventive compositions possess advantageous adhering properties, in particular to vertical surfaces. Furthermore, the inventive compositions also show advantageous foam-generating properties when brought into contact with water.

The inventive compositions also possess advantageous water solubilities and dissolution rates in water. In sanitary applications such as in a toilet bowl, the inventive compositions in the form of a gel can only be removed completely after numerous flushing processes. For example, 4 g of an inventive composition can preferably only be removed completely after more than 100, more preferably after more than 130 and even more preferably after more than 150 flushes.

Preferably, in the blend of N-hydrocarbon-N-acylglucam ides of the formula (I) of component a) of the inventive compositions, R₁CO is an acyl group comprising linear saturated alkyl groups R₁ with 7 to 17 carbon atoms and comprising a linear mono- or polyunsaturated, preferably monounsaturated, alkenyl group R₁ with 17 carbon atoms.

In a preferred embodiment of the invention, the additives c) are one or more substances selected from the group consisting of non-ionic surfactants other than glucamides of formula (I), cationic surfactants, anionic surfactants, amphoteric surfactants, auxiliaries which are customary and specific in each case, for example additives for dissolution time control, additives for performance improvement (e.g. soil release polymers; dye fixatives; dye transfer inhibitors; bleach systems; biocides or antimicrobial components; or builders) or washing assistants (e.g. enzymes; enzyme stabilizers; preservatives; foam enhancers; foam inhibitors; corrosion inhibitors; optical brighteners; UV absorbers; alkalis; hydrotropic compounds; antioxidants; solvents; salts or extenders; dispersants; graying inhibitors; softeners; antistats; dyes; fragrances or perfumes); dyes; pigments; colorants or pearlizing agents.

Nonionic surfactants other than glucam ides of formula (I) that may be contained in the inventive compositions are alkanolam ides, alkyldimethyl-amineoxides, di-alkyl-methylamineoxides, alkylamidopropyl-amine oxides, fatty acid-N-methylglucam ides different from those of component a) of the inventive compositions, alkylpolyglucosides, oxalkylated fatty acids, alkoxylated alcohols (alkyl ethers, alkyl polyethylene glycol ethers, fatty alcohol polyglycol ethers), (EO/PO) ethoxylated/propoxylated block copolymers, oxalkylated fatty acid esters and oxalkylated alkylamines. The alkyl and fatty acid groups of these compounds, which also may be fully or partially replaced by the corresponding unsaturated groups, may contain 8 to 22 carbon atoms and may be linear or branched. Oxalkylated means products that contain preferably 1 to 20 units of ethylene oxide or propyleneoxide or mixtures thereof.

The amount of the one or more other nonionic surfactants which can be added to the inventive compositions preferably is of from 0.1 to 50% by weight and more preferably of from 0.5 to 25% by weight.

The inventive compositions may contain one or more alcohol ethoxylates of formula (II) as non-ionic surfactants

R³—O—(CH₂CH₂O)ₙ—H (II)
wherein
R³ is a linear or branched, preferably a linear, saturated alkyl group comprising 12 to 22, preferably 12 to 20 and more preferably 16 to 18, carbon atoms or a linear or branched, preferably a linear, mono- or polyunsaturated alkenyl group comprising 12 to 22, preferably 12 to 20 and more preferably 16 to 18, carbon atoms,
   whereby the alcohol R³—OH underlying the respective alcohol ethoxylate of the formula (II) possesses a iodine number of from 30 to 135 g (J₂)/100 g alcohol R³—OH and preferably of from 36 to 120 g (J₂)/100 g alcohol R³—OH, and
n on a molar average, is a number of from 4 to 50 and preferably of from 5 to 25.

Preferred compositions of the present invention do not contain any alcohol ethoxylates, especially no alcohol ethoxylates of formula (II).

As cationic surfactants there may be used quaternary ammonium compounds such as alkyldimethyl-hydroxyethyl-ammonium. Instead of alkyl these ammonium compounds may also have alkenyl groups or mixtures of both. The alkyl as well as the alkenyl groups may contain 8 to 22 carbon atoms. They may be linear or branched. Preferred ammonium compounds are C₈-C₂₂-alkyl- or alkenyl-dimethyl-hydroxyethyl-ammonium compounds. Particularly preferred ammonium compounds are C₁₂/C₁₄-alkyl dimethyl hydroxyethyl ammonium compounds. All mentioned ammonium compounds may contain any kind of anion, the preferred ones are chloride, bromine, acetate, lactate, sulfate or methosulfate. A very preferred ammonium compound is C₁₂/C₁₄-alkyl dimethyl hydroxyethyl ammonium chloride.

Anionic surfactants may be selected from the group consisting of alkyl sulfates, alkyl ether sulfates, alkyl aryl sulfonates such as a linear alkylbenzene sulfonate (LAS), fatty acid soaps, methyl ester sulfonates, paraffin sulfonates, olefin sulfonates, alcohol ethoxysulfates, mono- and dialkyl sulfosuccinates, mono- and dialkyl sulfosuccinamates, sulfotriglycerides, amide soaps, ether carboxylic acids and salts thereof, fatty acid isethionates, fatty acid sarcosinates, fatty acid taurides, N-acyl amino acids such as, for example, acyl lactylates, acyl tartrates, acyl glutamates and alkyl oligoglucoside sulfates.

Furthermore, the compositions according to the invention may contain 0.1 to 12% by weight and preferably 0.2 to 10% by weight of amphoteric surfactants. The amphoteric surfactants may be alkyl amidopropyl betaines, alkyl dimethyl betaines, alkyl amphoacetates or -diacetates. The alkyl groups of these compounds, which may be partially or fully replaced by alkenyl groups, may contain 8 to 22 carbon atoms and may be linear or branched. The polyalkylene glycol groups may contain 1 to 20 ethoxy and/or propoxy units.

Depending on the intended use, the formulations according to the invention may comprise, in addition to said surfactants and auxiliaries additional additives which are customary and specific in each case, for example additives for dissolution time control or additives for performance improvement.

Suitable additives for dissolution time control are ethanol, isopropanol; butylglycol; di-butylglycol; mono-, di-, tri- or tetra-C₂-C₅ alkylene glycol such as ethylene glycol or propylene glycol, in particular mono-, di-, tri-, or tetra-propylene glycol; polyethylene glycols (PEGs) having molecular weights of at least 400, in particular PEGs of molecular weight ranging from 6,000 to 35,000; glycerol; sugar; and mixtures thereof.

In a preferred embodiment of the invention additives c) comprise propylene glycol and/or glycerol, most preferred propylene glycol and glycerol.

Suitable additives for performance improvement include soil release polymers; dye fixatives; dye transfer inhibitors; bleach systems; biocides or antimicrobial components; or builders.

Suitable soil release polymers are copolymers of acrylic acid and maleic acid (Sokalan® CP—BASF), homo- and copolymers of vinylpyrrolidone, vinylimidazole and nonionic monomers (Sokalan® HP—BASF), homopolymers of acrylic acid (Sokalan® PA—BASF), polyethylene terephthalate (PET) and polyoxyethylene terephthalate (POET) (Texcare® products—Clariant). Further suitable soil release polymers are, for example, cellulose ethers or polycondensates based on dibasic carboxylic acids and reactants which possess two or more hydroxyl groups. The dibasic carboxylic acid used is typically terephthalic acid. These soil release polymers may be nonionic or anionic.

The dye fixatives which can be incorporated into inventive compositions are nonionic or cationic and are described below:

Polycondensates which can be used as dye fixatives are obtained by the reaction of cyanamides with aldehydes and ammonium salts and/or monoamines (e.g. dye fixative DF3), by the reaction of monoamines and/or polyamines with epichlorohydrin (e.g. dye fixatives DF2 and DF4) or by the reaction of polyamines with cyanamides and amidosulfuric acid (e.g. dye fixative DF1). The monoamines used may be primary, secondary and tertiary amines. They may be aliphatic amines, for example dialkylamines, especially dimethylamine, alicyclic amines, for example cyclohexylamine, and aromatic amines, for example aniline. However, the amines used may also simultaneously have aliphatic, alicyclic and aromatic substituents. In addition, it is also possible to use heterocyclic compounds, for example pyridine.

The term “polyamines” here includes, for example diamines, triamines, tetraamines, etc, and also the analogous N-alkylpolyamines and N,N-dialkylpolyamines. Examples thereof are ethylenediamine, propylenediamine, butylenediamine, pentylenediamine, hexylenediamine, diethylenetriamine, triethylenetetraamine and higher polyamines. Particularly preferred polyamines are ethylenediamine, diethylenetriamine and dimethylaminopropylamine. The ammonium salts are salts of ammonia, especially ammonium chloride or the abovementioned amines or polyamines with different inorganic or organic acids, or else quaternary ammonium salts.

The cyanamides may be cyanamide or dicyandiamide.

Aldehydes which can be used for the synthesis of the dye fixatives are, for example, aliphatic aldehydes, for example formaldehyde, acetaldehyde, propionaldehyde, butyraldehyde; dialdehydes, for example glyoxal; unsaturated aldehydes, for example acrolein, crotonaldehyde and aromatic aldehydes, for example benzaldehyde. Particular preference is given to the aliphatic aldehydes, especially formaldehyde.

The dye fixatives used may also be homo- and copolymers based on diallyldimethylammonium chloride (DADMAC) (e.g. dye fixatives DF5, DF6 and DF7).

Copolymers based on DADMAC contain, as further components, other vinylic monomers, for example vinylimidazole, vinylpyrrolidone, vinyl alcohol, vinyl acetate, (meth)acrylic acid/ester, acrylamide, styrene, styrenesulfonic acid, acrylamidomethylpropanesulfonic acid, etc. Homopolymers based on DADMAC are obtainable under the trade name Genam in® PDAC (from Clariant).

Bleach systems such as inorganic peroxygen compounds, especially hydrogen peroxide and solid peroxygen compounds which dissolve releasing hydrogen peroxide in water, such as sodium perborate and sodium carbonate perhydrate and mixtures thereof; and bleach activators, such as those from the substance classes of the N- or O-acyl compounds, for example polyacylated alkylenediamines, especially tetraacetylethylene-diamine and tetraacetylglycoluril, N-acylated hydantoins, hydrazides, triazoles, hydrotriazines, urazoles, diketopiperazines, sulfurylam ides and cyanurates, and also carboxylic anhydrides, especially phthalic anhydride and substituted maleic anhydrides, carboxylic esters, especially sodium acetoxybenzenesulfonate, sodium benzoyloxybenzenesulfonate (BOBS), sodium nonanoyloxybenzenesulfonate (NOBS), sodium isononanoyloxy-benzenesulfonate (ISONOBS), and acylated sugar derivatives such as pentaacetylglucose, and mixtures thereof.

Biocides or antimicrobial components are any known ingredient having the ability of reducing or eliminating by killing or removing the micro-organisms existing on a surface. Biocides or antimicrobial components useful herein include alcohols, aldehydes, formaldehyde releasing compounds, phenolics, acid esters carbamates, amides, dibenzamidines, pyridine derivatives and related compounds, azoles, heterocyclic N,S compounds, N haloalkylthio compounds, compounds with activated halogen atoms, surface active agents, organometallic compounds, thiocyanates, biphenyl, triazine, oxidizing agents and mixtures thereof.

Suitable builders are organic and inorganic builders and are neutral or, in particular, alkaline salts which are able to precipitate out calcium ions or bind calcium ions to form a complex. Suitable and particularly ecologically acceptable builder substances, such as finely crystalline, synthetic hydrous zeolites preferably the type NaA, which have a calcium-binding capacity in the range from 100 to 200 mg of CaO/g, are used in preference. Zeolite and phyllosilicates can be present in the composition in an amount up to 20% by weight. Organic builders which can be used are, for example, the group consisting of amino carboxylic acid, organo aminophosphonic acid compounds, and mixtures thereof. Those components, which are acidic in nature, having for example phosphonic acid or carboxylic acid functionalities, may be present either in their acid form or as a complex/salt with a suitable counter cation such as an alkali or alkaline metal ion, ammonium, or substituted ammonium ion, or any mixtures thereof. Suitable components for use herein include the amino carboxylic acids such as ethylenediamine-N,N′-disuccinic acid (EDDS), ethylenediamine tetraacetic acid (EDTA), N-hydroxyethylenediamine triacetic acid, nitrilotriacetic acid (NTA), ethylene diamine tetrapropionic acid, ethylenediamine-N,N′-diglutamic acid, 2-hydroxypropylenediamine-N,N′-disuccinic acid, triethylenetetraamine hexacetic acid, diethylenetriamine pentaacetic acid (DETPA), trans 1,2 diaminocyclohexane-N,N,N′,N′-tetraacetic acid or ethanoldiglycine. Other suitable components for use herein include the organo aminophosphonic acids such as ethylenediamine tetrakis (methylenephosphonic acid), diethylene triamine-N,N,N′,N″,N″-pentakis (methylene phosphonic acid) (DETMP), 1-hydroxyethane 1,1-diphosphonic acid (HEDP) or hydroxyethane dimethylenephosphonic acid. It is also possible to use polymeric carboxylates and salts thereof. These include, for example, the salts of homopolymeric or copolymeric polyacrylates, polymethylacrylates and in particular, copolymers of acrylic acid with maleic acid, and also polyvinylpyrrolidone and urethanes. The relative molecular mass of the homopolymers is generally between 1000 and 100,000, that of the copolymers is between 2000 and 200,000, preferably 50,000 to 120,000, based on the free acid, in particular water-soluble polyacrylates which have been crosslinked, for example, with approximately 1% of a sugar polyallyl ether and which have a relative molecular mass above one million are also suitable. Examples thereof are the polymers obtainable under the name Carbopol® 940 and 941.

In general, additionally present in small use concentrations may be additive constituents which can be summarized under the term “washing assistants” and which thus include different active substance groups such as for example enzymes, especially proteases, lipases, cellulases, amylases and mannanases; enzyme stabilizers; preservatives; foam enhancers; foam inhibitors such as silicone oils or paraffins; corrosion inhibitors; optical brighteners; UV absorbers; alkalis; hydrotropic compounds; antioxidants; solvents; salts or extenders; dispersants; graying inhibitors; softeners; antistats; dyes, fragrances and perfumes.

Suitable enzymes are those from the class of proteases, lipases, amylases and their mixture. Their proportion can be from 0.1 to 1% by weight. The enzymes can be adsorbed to carrier substances and/or embedded into coating substances.

Suitable preservatives are, for example, phenoxy ethanol, formaldehyde solution, pentanediol or sorbic acid.

In a further preferred embodiment of the invention the additives c) comprise one or more solvents, preferably lower alkyl ethers of ethylene glycol, propylene glycol, polyethylene glycol and polypropylene glycol. “Lower alkyl” preferably means alkyl groups with 1 to 4 carbon atoms.

Suitable salts or extenders are, for example, sodium chloride, sodium sulfate, sodium carbonate, sodium silicate (water glass), magnesium chloride, or magnesium sulfate.

The aesthetics of the inventive compositions may be further enhanced by the addition of a dye, pigment, colorant or a pearlizing agent. Typical examples of dyes are methylene blue (Basic Blue 9), Direct Yellow 50, Solvent Red 17, Reactive Green 12 (Phthalocyanine, Clariant).

In a more preferred embodiment of the present invention, the inventive compositions comprise one or more substances selected from the group consisting of preservatives, antimicrobial components, enzymes, dye transfer inhibitors, soil release polymers, cationic surfactants, anionic surfactants, amphoteric surfactants, propylene glycol, glycerol, dyes, pigments and fragrances.

Preferably, the inventive compositions are solid at a temperature of 20° C.

More preferably, the inventive compositions are present, at a temperature of 20° C., in the form of a gel or in the form of a paste and preferably in the form of a gel. Among the inventive compositions being present, at a temperature of 20° C., in the form of a gel, inventive compositions in monodose format or in the form of a monodose product constitute a preferred embodiment of the invention.

Even more preferably, the viscosity of the inventive compositions, measured at a temperature of 20° C. and a shear stress of 1000 Pa, is of from 40 to 9·10⁹ Pa·s and more preferably of from 1000 to 1.6·10⁸ Pa·s.

In a particularly preferred embodiment of the invention the inventive compositions are present in the form of a paste and the viscosity of these inventive compositions, measured at a temperature of 20° C. and a shear stress of 1000 Pa, is of from 40 to 1200 Pa·s.

In another particularly preferred embodiment of the invention the inventive compositions are present in the form of a gel and the viscosity of these inventive compositions, measured at a temperature of 20° C. and a shear stress of 1000 Pa, is of from 1200 to 9·10⁹ Pa·s and more preferably of from 1200 to 1.6·10⁸ Pa·s.

The viscosities of the inventive compositions are measured using a rheometer Haake Mars III (Thermofisher Scientific) with a 35 mm plate-plate geometry at 20° C.

Especially preferred inventive compositions exhibit viscoelastic properties and no flow when in the steady-state.

In a preferred embodiment of the present invention, the inventive compositions are present in the form of a monodose product and more preferably in the form of a monodose product and, at a temperature of 20° C., in the form of a gel.

Preferably, the average dissolution rate of the inventive compositions in water at a temperature of 20° C. is of from 1 to 100 mg/minute and preferably of from 10 to 80 mg/minute.

Furthermore preferably, the average dissolution rate of the inventive compositions in water at a temperature of 20° C. is of from 1 to 40 mg/minute and preferably of from 10 to 40 mg/minute and at a temperature of 30° C. is of from 40 to 100 mg/minute and preferably of from 40 to 80 mg/minute.

The inventive compositions melt at a temperature of at least 45° C., preferably at a temperature between 55° C. and 75° C. The melting point of the inventive compositions can be determined by differential scanning calorimetry using a heating rate of 10 K/min according to DIN EN ISO 11357.

The compositions of the present invention are characterized by being self-adhesive. Thus, no tackifiers or adhesion promotors are required for sufficient adhesion to various surfaces. But tackifiers or adhesion promotors may be used, if desired.

In a further preferred embodiment of the present invention the inventive compositions consist of the components a), b) and c).

Preferably, the inventive compositions are adhering to vertical surfaces and more preferably to vertical surfaces made of ceramics, plastic or stainless steel.

Preferably, the inventive compositions generate foam when rinsed or flushed with water.

The invention also relates to a process for the preparation of the above-described compositions, preferably being present, at a temperature of 20° C., in the form of a gel or in the form of a paste and more preferably in the form of a gel, said process being characterized in that components a) and b) or a), b) and a part or the total amount of c) are heated to a temperature of from 45 to 80° C. and preferably of from 50 to 75° C., preferably under mixing, until a homogeneous melt is obtained and then the homogeneous melt is cooled down, preferably to a temperature of from 20 to 45° C., and that in case the composition to be heated contains no component c) or contains only a part of the total amount of component c) the remaining part or the total amount of component c) is added to the homogeneous melt during the heating and/or during the cooling thereof.

In a preferred embodiment of the process of the invention a part or the total amount of additives c) is added during the heating of components a), b) and optionally c) or during the cooling of the homogeneous melt.

Inventive compositions comprising components a), b) and c) generally are present in the form of gels. These gels may also comprise besides water additional solvent components in moderate amounts, such as propylene glycol and/or glycerol in amounts of 10% by weight or less and preferably in amounts of 8% by weight or less. The inventive compositions may also be present in the form of a paste if they comprise preferably solvent components, such as propylene glycol and/or glycerol in relatively high amounts.

Type and amount of additional solvent components—if present besides water—are selected to result in inventive compositions with melting points of 45° C. and more.

In another preferred embodiment of the present invention the inventive compositions comprise besides water one or more additional solvent components these being contained in the inventive compositions preferably in an amount of 20% by weight or less, more preferably in an amount of 10% by weight or less and even more preferably in an amount of 8% by weight or less, the amounts of the one or more solvent components being based on the total weight of the composition. Among the inventive compositions comprising one or more solvent components those comprising propylene glycol and glycerol are preferred.

In a particularly preferred embodiment of the invention the inventive compositions consist of components a), b) and c), wherein component c) comprises propylene glycol and glycerol.

In another preferred embodiment the inventive compositions comprise no or up to 3% by weight, referring to the total amount of the composition, of methanol and/or ethanol and very preferred 10% by weight or less of propylene glycol and/or of glycerol and no or up to 3% by weight of methanol and/or ethanol.

The inventive compositions are advantageously suited for cleaning, scenting, conditioning or disinfection purposes, preferably in home or personal care applications.

Therefore, a further subject matter of the present invention is the use of the inventive compositions for cleaning, scenting, conditioning or disinfection purposes, preferably in home or personal care applications.

Due to the presence of the one or more N-hydrocarbon-N-acylglucam ides of the formula (I) of component a), the inventive compositions consisting of components a), b) and c), i.e. without the presence of further substances in addition to components a), b) and c), could be used for cleaning purposes or cleaning applications. However, also for this purpose or application the addition of further substances in addition to components a), b) and c) to the inventive compositions is possible. For scenting or disinfection purposes or applications components a), b) and c) of the inventive compositions may e.g. be used as a base composition or a “chassis”, i.e. for these purposes or applications the inventive compositions might comprise additional substances as component c), such as components with respective activities, e.g. perfumes or components with disinfection properties.

For use the inventive compositions are preferably applied to surfaces made of ceramics, plastic or stainless steel, more preferably to toilet ceramics, or are applied in laundry machines or dishwashers.

The inventive compositions present in the form of a paste may preferably be used in hand dishwashing, laundry and hard surface cleaning applications.

The inventive compositions present in the form of a gel may preferably be used in laundry, automatic dishwashing, hand dishwashing, hard surface cleaning, toilet, air care and personal care applications.

The invention also relates to the use of a composition comprising components a), b) and c) as described above for preparation of a gel or paste which is self-adhering at the surface of an object, preferably of a sanitary object.

The examples below serve to illustrate the invention in more detail without limiting it thereto. All amounts are given as % by weight (wt.-%).

In the examples the following substances have been used:

| | |
|---|---|
| Genagen ® CAB 818 | Cocamidopopyl betaine |
| | (Clariant, 30 wt. -% in water) |
| Genapol ® LRO | C₁₂/C₁₄-alkyldiglycolethersulfate |
| | sodium salt (Clariant) |

The N-methyl-N-acylglucam ides described and utilised in the following examples 1 to 7 were prepared according to EP 0 550 637 from the corresponding fatty acids methyl esters or triglycerides and N-methylglucamine in the presence of 1,2-propylene glycol.

In the following Table 1, “na” means “not applicable”.

TABLE 1
Examples 1-7

| | Weight-% of active component | | | | | | |
|---|---|---|---|---|---|---|---|
| | Example 1¹⁾ | Example 2¹⁾ | Example 3 | Example 4¹⁾ | Example 5 | Example 6¹⁾ | Example 7¹⁾ |
| Component | (inventive) | (inventive) | (comparative) | (inventive) | (comparative) | (inventive) | (inventive) |
| N-methyl-N-C₈/C₁₀- | 16.2 | 21.7 | 8.0 | 3.5 | 9.8 | 8.0 | 3.5 |
| acylglucamide | | | | | | | |
| N-methyl-C₁₂/C₁₄- | 44.9 | 39.6 | 39.6 | 17.4 | 64.9 | 39.6 | 17.4 |
| acylglucamide | | | | | | | |
| N-methyl-N- | 5.2 | 5.2 | 29.7 | 26.9 | 6.3 | 5.2 | 2.3 |
| oleylglucamide | | | | | | | |
| additional N-methyl- | 4.6 | 4.6 | 6.7 | 4.2 | 5.6 | 4.6 | 2.0 |
| N-acylglucamides | | | | | | | |
| Cocamidopopyl | 0 | 0 | 0 | 0 | 0 | 9.0 | 0 |
| betaine | | | | | | | |
| C₁₂/C₁₄-alkyl- | 0 | 0 | 0 | 0 | 0 | 0 | 21.0 |
| diglycolether-sulfate | | | | | | | |
| sodium salt | | | | | | | |
| Water | 25.9 | 26.1 | 12.8 | 37.6 | 6.6 | 19.9 | 46.1 |
| Propylene glycol | rest | rest | rest | rest | rest | rest | rest |
| and glycerol | | | | | | | |
| Physical state of the | Gel | Gel | Inhomogeneous | Gel | Liquid phase, | Gel | Gel |
| sample after cooling | | | phase, no | | no gel | | |
| down to 25° C. | | | gel formation | | formation | | |
| Stability under | stable gel | stable gel | na | stable gel | na | stable gel | stable gel |
| storage at | phase | phase | | phase | | phase | phase |
| 40-60% r.h., 24° C. | >3 months | >3 months | | >3 months | | >3 months | >3 months |

¹⁾sample melts above 45° C.; melting determined by heating and visually inspecting sample

The compositions of the inventive Examples 1, 2, 4, 6 and 7 and of the Comparative Examples 3 and 5 have been prepared in the following way:

Components a), b) and c) were mixed and heated from 50 to 75° C. until a homogeneous melt was obtained. Afterwards the homogeneous melt was cooled down to 25° C.

All gels of Examples 1, 2, 4, 6 and 7 are soft and deformable. They may easily be transformed into monodose formats or monodose products by either casting the homogeneous melt of the preparation process into a respective form or by cutting and/or pressing the gels in order to obtain the desired form.

The gels of Example 1 and 2 were further examined:

The gels of Example 1 and Example 2 show viscosity at a shear stress of 1000 Pa 1.5·10⁷ Pa·s and 8.8·10⁷ Pa·s, respectively. Viscosity characterization was performed using a rheometer Haake Mars III (Thermofisher Scientific) with a 35 mm plate-plate geometry at 20° C.

The gels of Example 2 and Example 4 were applied as monodose products to the ceramics of a toilet bowl and the adhesive properties of the gels have been tested. The gels could only be removed completely after approximately 150 and 130 flushing operations respectively which demonstrates that the gels of Example 2 and Example 4 possess very advantageous adhesive properties.

The inventive gel of Example 6 comprises 9.0 wt.-% of cocamidopropyl betaine which is an example of an amphoteric surfactant and therefore, the gel of Example 6 could be used for cleaning purposes or in cleaning applications.

The inventive gel of Example 7 comprises 21 wt.-% of C₁₂/C₁₄-alkyl-diglycolether-sulfate sodium salt which is an example of an anionic surfactant. This composition is an example of a gel with enhanced solubility and can be used among others in monodose systems for cleaning and scenting purposes in cleaning applications.

1. A composition melting at a temperature of at least 45° C. comprising:
a) 20 to 84 wt.-% of a blend of N-hydrocarbon substituted-N-acylglucamides of the formula (I) 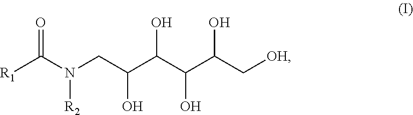
wherein
R₁ is a linear or branched, alkyl group comprising 7 to 21 carbon atoms or a linear or branched, mono- or polyunsaturated alkenyl group comprising 7 to 21 carbon atoms,
R2 is a linear or branched alkyl group or an aryl group,
wherein the blend of N-hydrocarbon substituted-N-acylglucamides comprises:
(a1) 3 to 35 wt.-% of at least one N hydrocarbon-N-acylglucamide of formula (I), wherein R₁ is a linear or branched, alkyl group comprising 7 to 9 carbon atoms or a linear or branched, mono- or polyunsaturated alkenyl group comprising 7 to 9 carbon atoms,
(a2) 15 to 75 wt.-% of at least one N-hydrocarbon-N-acylglucamide of formula (I), wherein R₁ is a linear or branched, alkyl group comprising 11 to 13 carbon atoms or a linear or branched, mono- or polyunsaturated alkenyl group comprising 11 to 13 carbon atoms,
(a3) 2 to 55 wt.-% of at least one N hydrocarbon-N-acylglucamide of formula (I), wherein R₁ is a linear or branched, mono- or polyunsaturated alkenyl group comprising 11 to 17 carbon atoms, which are different from the N-hydrocarbon-N-acylglucamide(s) of components (a2) and (a4), and
(a4) 2 to 12 wt.-% of at least one additional N-hydrocarbon-N-acylglucamide of formula (I) which is different from the N-hydrocarbon-N-acylglucamides of components (a1), (a2), and (a3),
b) 15 to 50 wt.-% of water, and
c) 1 to 30 wt.-% of at least one additive, wherein the total amount of components a) and c) is at least 50 wt.-%, and wherein the percentages refer to the total weight of the composition

2. The composition according to claim 1, wherein the total amount of components a) and c) is at least 55 wt.-%, based of the total weight of the composition.

3. The composition according to claim 1, wherein the at least one additive of component c) is selected from the group consisting of preservatives, antimicrobial components, enzymes, dye transfer inhibitors, soil release polymers, cationic surfactants, anionic surfactants, nonionic surfactants, amphoteric surfactants, builders, corrosion inhibitors, propylene glycol, glycerol, dyes, pigments and fragrances.

4. The composition according to claim 3, wherein the at least one additive of component c) is selected from the group consisting of propylene glycol and glycerol.

5. The composition according to claim 1, wherein component (a1) is selected from the group consisting of at least one N hydrocarbon-N-acylglucamide of formula (I), wherein R₁ is a linear or branched, alkyl group comprising 7 to 9 carbon atoms, component (a2) is selected from the group consisting of at least one N hydrocarbon-N-acylglucamide of formula (I), wherein R₁ is a linear or branched, alkyl group comprising 11 to 13 carbon atoms, (a3) is selected from the group consisting of at least one N-hydrocarbyl-N-acylglucamide, wherein R₁ is a linear, mono- or polyunsaturated alkenyl group comprising 11 to 17 carbon atoms, and (a4) is selected from the group consisting of at least one additional N-hydrocarbon-N-acylglucamide of the formula (I) which are different from the N-hydrocarbon-N-acylglucamides of components (a1), (a2), and (a3), and wherein R₁ is a linear or branched, alkyl group comprising 7 to 21 carbon atoms.

6. The composition according to claim 1, wherein the composition is solid at a temperature of 20° C.

7. The composition according to claim 1, wherein the composition at a temperature of 20° C., is in the form of a gel or in the form of a paste.

8. The composition according to claim 1, wherein the composition has a viscosity, measured at a temperature of 20° C. and a shear stress of 1000 Pa, of from 40 to 9·10⁹ Pa·s.

9. The composition according to claim 1, wherein the composition is present in the form of a monodose product and, at a temperature of 20° C., in the form of a gel.

10. The composition according to claim 1, wherein the composition adheres to vertical surfaces.

11. The composition according to claim 1, wherein the composition generates foam when rinsed or flushed with water.

12. The composition according to claim 1, wherein the composition melts at a temperature between 55° C. and 75° C.

13. The composition according to claim 1, wherein the composition does not contain any alcohol ethoxylates.

14. A process for the preparation of a composition according to claim 1, comprising the steps of heating components a) and b) or a), b) and a part or the total amount of c) to a temperature of from 45 to 80° C., until a homogeneous melt is obtained, then cooling the homogeneous melt, and adding the remaining part or the total amount of component c) to the homogeneous melt during the heating and/or during the cooling thereof.

15. A method for cleaning, washing, scenting, conditioning or disinfecting a surface, comprising the step of contacting the surface with at least one composition according to claim 1.

16. The method according to claim 15, wherein the composition is applied directly to a surface of an object, and wherein the composition is self-adhering at the surface of the object.

17. (canceled)
